(19) United States
(12) Patent Application Publication
(10) Pub. No.: US 2016/0294579 A1
(43) Pub. Date: Oct. 6, 2016

(54) Pinless Connector

(71) Applicants: Andy Hernandez-Fabian, Brick, MD (US); Ivan Touevski, Toms River, NJ (US); Glenn Shevach, Lakewood, NJ (US)

(72) Inventors: Andy Hernandez-Fabian, Brick, MD (US); Ivan Touevski, Toms River, NJ (US); Glenn Shevach, Lakewood, NJ (US)

(73) Assignee: United States of America as represented by the Secretary of the Navy, Patuxent River, MD (US)

(21) Appl. No.: 14/277,895

(22) Filed: May 15, 2014

(51) Int. Cl. H04L 12/40; H04B 10/40

(52) U.S. Cl. CPC H04L 12/40169; H04B 10/40

(57) ABSTRACT

The invention is directed to a pinless connector having two interconnecting halves. Each half has an embedded communications device designed to receive and transmit signals via an infrared communications protocol. The connectors are designed to withstand extreme environmental conditions, and alleviate the need for frequent connector replacement due to damaged or broken pins cause by frequent disconnection and reconnection and, thus, facilitate the fast removal of weapon replaceable assemblies.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a novel pinless connector that replaces traditional to pin and socket connectors. More specifically, but without limitation, the present invention is an electronic connector, meeting military specifications, containing powered circuitry in each end to communicate with the opposing end via infrared light.

Military personnel often operate military aircraft in the extreme weather and around harsh environmental conditions that include dirt and sand. They also conduct missions that require the frequent removal and swapping of equipment, particularly avionic equipment for testing and evaluation. Exposure of avionic equipment connectors to extreme weather and harsh environments may lead to pin corrosion which causes the shorting and degradation of pin connections and the frequent removal and re-installation of equipment leads to bent and broken pins rendering the equipment inoperable and therefore requiring significant repair, replacement time and monetary costs.

Moreover, traditional connectors, even under normal use, are subject to mechanical and environmental stresses that degrade their effectiveness and jeopardize the integrity of the system. Bent, broken and corroded pins are common occurrences in connectors for many different kinds of equipment. These are maintenance issues that require a significant amount of time, manpower, and money to identify and remedy.

Therefore, what is needed is an electronic connector that eliminates the need for pins through the use of non-contact methods and has the mechanical integrity to maintain communication in harsh environments and through repeated disconnections and reconnections.

### SUMMARY

The present invention is directed to a pinless connector for electronic devices that replaces traditional pin and socket connectors. Data is communicated using a method that does not require physical electrical contact between the transmitting and receiving equipment such as infrared or the like. Small ruggedized modules are attached to the end of a cable connected to an electronic device and interfaced with another such connector on the end of a cable connected to a separate electronic device. Alternatively the connectors can be machined or fixed directly onto the electronic devices to eliminate the need for cables. As with a traditional connector, the actual interface is transparent to the equipment generating and receiving information to and from the data bus.

An embodiment of the connector has housing with opposing, interconnecting halves. Each half of the housing has an embedded printed circuit board. A power supply is electrically connected to each printed circuit board. Each printed circuited board comprises a logic unit, a transceiver in electrical communication with the logic unit, and a radiating element, such as a micro antenna in electrical communication with the transceiver.

The processor on the printed circuit board accepts a communication signal from the electronic device and transmits it to the logic unit. The logic unit receives and processes the communication signal and transmits the communication signal to the transceiver. The transceiver receives the processed communication signal and transmits it via an electronic radiating element to an electronic transceiver element in the opposite half of the housing. The signal is preferably an infrared transmission.

The connector housing halves are made of material that prevents signal leakage. The housing halves also have flush, open connector faces that allow the communications signal to pass through and can be hermetically sealed together.

### DRAWINGS

These and other features, aspects and advantages of the present invention will become better understood with reference to the following description and appended claims, and accompanying drawings wherein:

FIG. 1 is an embodiment of the pinless connector with twist and lock connector halves.

FIG. 2 is an embodiment of a military specification version of the pinless connector with twist and lock connector halves.

FIG. 3 is an alternate embodiment of the pinless connector with tongue and groove locking connector halves.

### DESCRIPTION

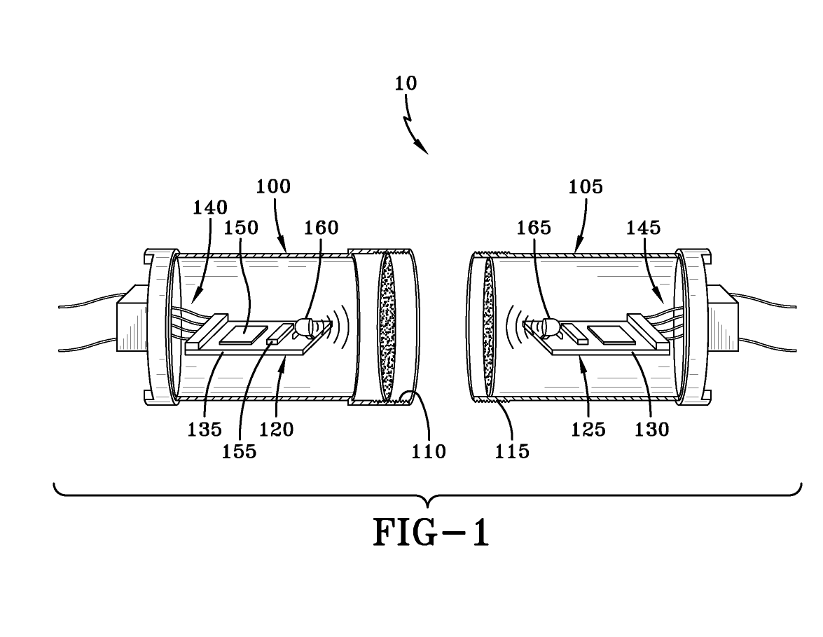

The preferred embodiments of the present invention are illustrated by way of example below and with reference to FIGS. 1-3. The pinless connector of the subject invention was designed to connect interfacing equipment and maintain operation effectiveness during high use and under extraordinary conditions such as extreme weather and harsh environments. This makes the connector ideal for military applications, such as connecting avionic equipment to aircraft and other diagnostic equipment for testing in the field. Also, if there is a need for a high use connector and the user is flexible with regard to real-time data communications or bandwidth requirements, the pinless connector of the present invention is an ideal solution to mitigate common degradation problems associated with these types of applications where connector pins often get damaged or destroyed.

FIG. 1 shows an embodiment of the present invention (10) that includes two interlocking cylindrical connector halves: A female half (100) and a male half (105). Each half is equipped with a twist and lock mechanism for interconnection. The end of the female half (100) has threads (110) on the inside of the cylinder to accept the male half of the connector (105) which has threads on its outside end (115). The housing of each connector half has an embedded transceiver system (120 and 125) fixed onto a multilayer printed circuit board (130 and 135) for sending and receiving electronic communications.

When in use, each half of the connector (10) is separately supplied with power through electronic connections (140 and 145) to separate pieces of electronic equipment that need to communicate with each other. The transceiver system (120) on the multilayer printed circuit board (135) comprises a logic unit (150) in communication with a transceiver (155). The logic unit (150) processes signals and transmits them to the transceiver (155) which sends them to a radiating element (160). The radiating element (160) then transmits the electronic signal to the radiating element (165) in the opposite end of the connector (105). The radiating element (165) may be any one of the various types of micro antennas, light emitting diode (LED) or the like that can transmit and receive electronic signals.

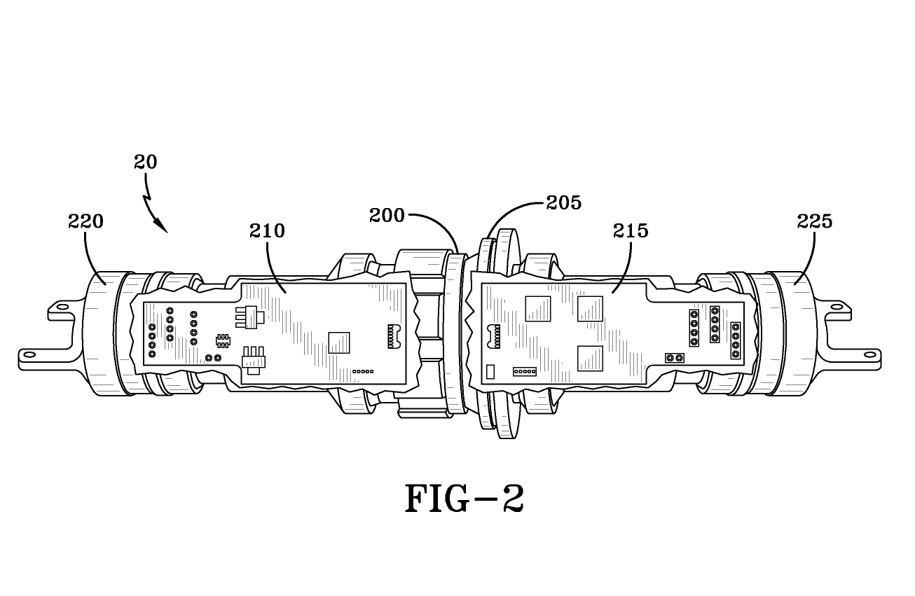

In one embodiment, the connector meets military specifications (Mil-Spec). That is, the connector is designed to a Department of Defense (DOD) standard to ensure reliability for military operations. Consequently, Mil-Spec equipment is sturdier and more robust than equipment used in civilian applications. FIG. 2 is an example of a Mil-Spec embodiment. In FIG. 2, there is a twist and lock connector (20) with flush connector faces (200 and 205) to facilitate electronic communication. The printed circuit boards (210 and 215) are embedded in opposing ends (220 and 225) of the connector (20). The connector (20) in FIG. 2 is manufactured to facilitate the operation of Weapons Replaceable Assembly (WRA) cable set. The connector (20) can be the interconnection between two WRAs or between a WRA and another piece of equipment. The connector (20) can also be embedded within a WRA to connect components. The connector is approximately an inch in diameter, but can vary in size and shape to meet equipment interface requirements. The outer shell is fabricated from a material designed to withstand extreme changes in temperature, be impermeable to foreign elements such as sand, salt and water, which can interfere with electronic signals, and to provide electromagnetic interference shielding, which prevents signal transmission leakage. The WRA connector uses common form factors that are representative of what is used in military aviation fleets.

Each end of the WRA connector (220 and 225) is electronically isolated from the other and can be interfaced with wires (not shown). Examples of the interfacing wires (140 and 145) that may be used with this embodiment are shown in FIG. 1. Thus, each connector end is separately powered. However, each connector module can share power via a contact or inductive method. The connector (20) is also designed to send customizable ARINC 429 (a standard avionics protocol) messages via an infrared signal. In addition to other functional components, such as voltage regulators and components to condition the power, the connector has an electronic micro-chip set/logic unit that accepts and processes the ARINC 429 protocol by buffering the signal, organizing data and decoding and encoding the signal. The logic unit then sends the signal to a transceiver to be transmitted via an antenna element to the opposing half of the connector.

While signals can be present on the pins of regular connectors they must be physically connected for one end of the connector to receive the signal. Unlike pinned connectors, the opposing ends of the connectors of the present invention do not require a physical connection to receive transmissions from each other. In contrast, because the pinless connector of this invention uses infrared technology, the ends of the connectors need only be within the infrared operating range of each other to transmit and receive signals. However, a link detection scheme can be implemented to stop data transmission if a physical link is not present.

Also, the hardware and software in each module of the connector is identical, therefore there is no need for separate addresses for synching or handshaking between modules. The modules have the capability for digital analysis, post processing and the modification of the received signals. In an embodiment of the connector, there are multiple ARINC 429 channels yielding multiple data lines. The connector is capable of employing the Institute of Electrical and Electronics Engineers (IEEE) 802.15.4 Zigbee wireless protocol that enables automatic communication, development software and 250 kbps RF data rate. Thus, the connector can provide a low powered transmission with relatively low signal latency.

Infrared light is capable of being transmitted over a wide spectrum range, extending from approximately 700 nm to 1 mm, corresponding to a frequency range of approximately 430 THz down to 300 GHz. Most infrared transceivers operate on the Universal Asynchronous Receive Transmit (UART) protocol with a standard serial communication speed of approximately 115 kb/s. This makes infrared the ideal medium for this application, because the power requirements are low, it is relatively inexpensive to produce, and it requires minimal processing circuitry.

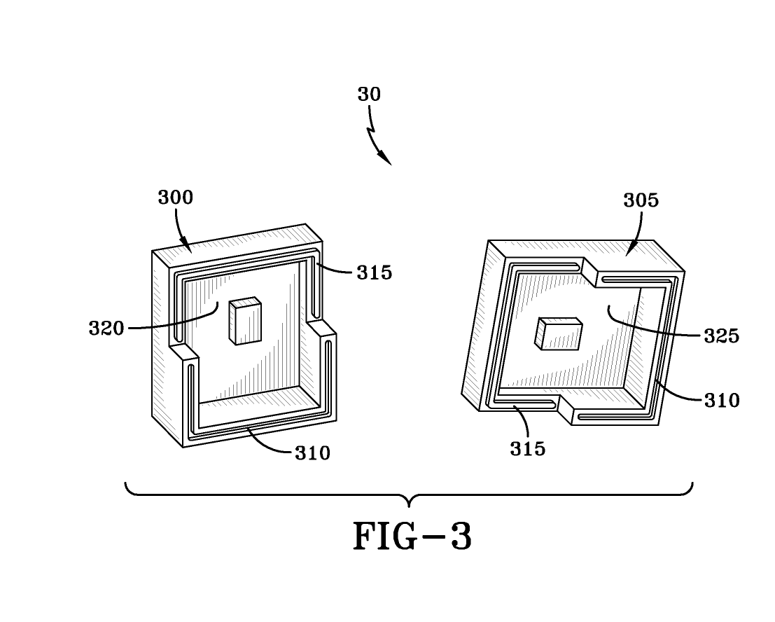

An alternative embodiment of a pinless connector is shown in FIG. 3. This connector (30) is fabricated from a plastic housing. Each half (300 and 305) has tongue and grove edges (310 and 315) that snap into place, securing it to the opposite half of the connector. The embedded printed circuit board and transceiver systems (320 and 325) are flatly embedded in either end of the connector and are vertically oriented to each other. This is in opposition to the horizontal circuit board arrangements of the embodiments of FIGS. 1 and 2, thus showing the versatility of the transceiver system. Each half of the system may have various orientations and still maintain communication, as long as the each half of the transceiver is within transmission and receiving distance of the other.

This pinless connector is very versatile and a viable alternative to regular connectors containing pins. It can be fabricated from a variety of materials, from plastics to metal, depending on the type of application in which it will be implemented. It can be used in a variety of commercial applications to replace USB ports, video and audio connectors and the like where the frequent plugging and unplugging of equipment bends and breaks the pins of normal connectors. Moreover, this technology is not limited to a separate connector application. It may be implemented inside a piece of communications equipment to connect various modules, or any other application where communications signals are to be transmitted between two pieces of electronic equipment

The above description is that of current embodiments of the invention. Various alterations and changes can be made without departing from the spirit and broader aspects of the invention as defined in the appended claims.

What is claimed is:

1. A connector for electronic devices comprising:
housing with opposing, interconnecting ends;
a printed circuit board embedded in each end of the housing; and
a power supply electrically connected to each printed circuit board;
wherein, each printed circuited board comprises:
a logic unit;
a transceiver in electrical communication with the logic unit; and
a radiating element in electrical communication with the transceiver.

2. The connector of claim 1, wherein the printed circuit board has a physical electrical connection to the electronic device.

3. The connector of claim 1, wherein the logic unit is designed to receive a communication signal from the electronic device, process the communication signal and transmit the communication signal to the transceiver.

4. The connector of claim 1, wherein the transceiver is designed to receive the processed communication signal and transmit it to the radiating element.

5. The connector of claim 1, wherein the radiating element is designed to receive the processed communication signal and transmit it to the radiating element in the opposing interconnecting end of the housing.

6. The connector of claim 1, wherein the printed circuit board is designed to receive, process, and transmit infrared signals.

7. The connector of claim 1, wherein the printed circuit board is designed to receive, process, and transmit radio frequency signals.

8. The connector of claim 1, wherein the printed circuit board is designed to receive, process, and transmit military specification protocol signals.

9. The connector of claim 1, wherein the interconnecting ends of the housing comprise flush, open connector faces that allow transmission of the communications signal.

10. The connector of claim 1, wherein in the housing is constructed of a material that prevents leakage of a communications signal.

11. The connector of claim 1, wherein the interconnecting ends of the housing are hermetically sealed together.

12. The connector of claim 1, wherein the connector is designed to be a part of a Weapons Replaceable Assembly.

13. A system for connecting pieces of electronic communications equipment, comprising:
interconnecting modules incorporated onto each piece of equipment;
a printed circuit board embedded inside each interconnecting module,
wherein each printed circuit board comprises:
a logic unit;
a transceiver; and
a radiating element.

14. The system of claim 13, wherein the printed circuit board has a wired connection to a first piece of the electronic communications equipment.

15. The system of claim 13, wherein the logic unit is designed to receive an electronic communications signal from the first piece of electronic communications equipment, process the electronic communications signal and transmit the electronic communications signal to the transceiver.

16. The system of claim 13, wherein the transceiver is designed to receive the processed communications signal from the logic unit, and transmit the communication signal, via the radiating unit, to the radiating unit in the interconnecting module on a second piece of equipment.

17. The system of claim 13, wherein the interconnecting modules comprise flush connector faces that allow a seamless connection between the pieces of electrical equipment.

18. The system of claim 13, wherein the printed circuit board is designed to receive, process, and transmit infrared signals.

19. The system of claim 13, wherein the printed circuit board is designed to receive, process, and transmit radio frequency signals.

20. The system of claim 13, wherein the printed circuit board is designed to receive, process, and transmit military specification protocol signals.

21. The system of claim 13, wherein in the interconnecting modules are constructed of a material that prevents leakage of a communications signal.

22. The system of claim 13, wherein the interconnecting modules of are hermetically sealed together.

23. The system of claim 13, wherein the interconnection modules are part of a Weapons Replaceable Assembly.
